(19) United States
(12) Patent Application Publication
(10) Pub. No.: US 2022/0179410 A1
(43) Pub. Date: Jun. 9, 2022

(54) Systems And Methods For Eliminating Vehicle Motion Interference During A Remote-Control Vehicle Maneuvering Operation

(71) Applicant: Ford Global Technologies, LLC, Dearborn, MI (US)

(72) Inventors: Erick Lavoie, Van Buren Charter Township, MI (US); Hemanth Yadav Aradhyula, Dearborn, MI (US); Seyed Armin Raeis Hosseiny, Canton, MI (US)

(73) Assignee: Ford Global Technologies, LLC, Dearborn, MI (US)

(21) Appl. No.: 17/112,441

(22) Filed: Dec. 4, 2020

(51) Int. Cl. G05D 1/00; B60W 40/105; G06F 3/01

(52) U.S. Cl. CPC G05D 1/0016; B60W 40/105; B60W 2420/403; G05D 2201/0213; B60W 2554/4041; G06F 3/017

(57) ABSTRACT

The disclosure generally pertains to a remote-control vehicle maneuvering system that includes a personal communication device configured to eliminate vehicle motion interference during a remote-control vehicle maneuvering operation. In an example scenario, an individual may stand in a vehicle having a trailer attached (or stand on the trailer) and perform actions upon the personal communication device so as to transmit commands to a vehicle controller of the vehicle for moving the vehicle backwards in a desired direction. The actions performed by the individual may include tilting the personal communication device to command the vehicle controller to increase a speed of the vehicle. While doing so, various factors such as an object on the road, may cause the vehicle to tilt, thereby increasing a tilt angle of the personal communication device and causing the vehicle to accelerate dangerously. The personal communication device is configured to eliminate interference caused by such factors.

### BACKGROUND

Operating a vehicle with a trailer in tow is very challenging for many drivers. This is particularly true for drivers that are unskilled at backing up vehicles with attached trailers. Such drivers may include those that drive with a trailer on an infrequent basis (e.g., drivers that rent a trailer). For example, when manually reversing a trailer, the direction of the steering wheel input may be counterintuitive to the resulting trailer direction.

Moreover, in remote control situations, a steering wheel angle that should be used to achieve a certain path shape may be difficult to keep straight as a perspective changes at different positions around the vehicle and trailer. Certain types of remote control operations that are carried out by using a remote control device for moving the trailer one way (e.g., back and to the left) may be intuitive to an individual when the individual is standing behind the vehicle but counter intuitive when the individual is standing in front of the vehicle. Furthermore, in certain situations, other factors may affect remote control operations, such as when an individual is standing on a bed of the vehicle (e.g., a pickup truck) or on a trailer and uses a handheld device to maneuver the vehicle and trailer.

It is therefore desirable to address various issues related to remote control operations such as the ones described above.

### DESCRIPTION OF THE FIGURES

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a first example scenario of a remote-control vehicle maneuvering operation in accordance with an embodiment of the disclosure.

FIG. 2 illustrates some operational features of a personal communication device used for maneuvering a vehicle in accordance with the disclosure.

FIG. 3 illustrates some components of a personal communication device in accordance with an embodiment of the disclosure.

FIG. 4 illustrates a second example scenario of a remote-control vehicle maneuvering operation in accordance with an embodiment of the disclosure.

FIG. 5 illustrates an exemplary situation that may be encountered during the remote-control vehicle maneuvering operation illustrated in FIG. 4.

FIG. 6 illustrates a third example remote-control vehicle maneuvering system operation in accordance with an embodiment of the disclosure.

FIG. 7 illustrates an exemplary situation that may be encountered during the remote-control vehicle maneuvering operation illustrated in FIG. 6.

FIG. 8 shows a flowchart of an example method to eliminate vehicle motion interference during a remote-control vehicle maneuvering operation, in accordance with the disclosure.

### DETAILED DESCRIPTION

### Overview

The systems and methods disclosed herein generally pertain to a remote-control vehicle maneuvering system that includes a personal communication device configured to eliminate vehicle motion interference during a remote-control vehicle maneuvering operation. In an example scenario, an individual may stand on a flatbed portion of a vehicle having a trailer attached (or stand on the trailer) and perform various actions upon the personal communication device. Such actions may involve transmitting commands to a vehicle controller of the vehicle for moving the vehicle backwards at a desired angle and desired direction. The actions performed by the individual upon the personal communication device may include, for example, tilting the personal communication device at a certain angle so as to command the vehicle controller to increase a speed of the vehicle. While doing so, various factors such as, for example, an object on the road surface, may cause the vehicle to tilt, thereby increasing a tilt angle of the personal communication device and causing the vehicle to accelerate dangerously. In accordance with the disclosure, the personal communication device is configured to eliminate interference caused by such factors.

### Illustrative Embodiments

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionalities described with respect to a particular device or component may be performed by another device or component. For example, some or all of the functionalities described herein with respect to a personal communication device may, in certain embodiments, be performed by a vehicle controller and/or another component of a vehicle. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used in this disclosure can pertain to any one of various types of vehicles, such as, for example, cars, vans, sports utility vehicles, trucks, electric vehicles, gasoline vehicles, hybrid vehicles, and autonomous vehicles. The phrase “personal communication device” as used herein refers to any of various types of devices that can be carried around by an individual. A few examples of personal communication devices, which can also be referred to as mobile devices, can include: a cellular phone, a smartphone, a tablet computer, a phablet (phone plus tablet computer), and a portable computer. Such personal communication devices may be used for executing various operations, including remote-control vehicle maneuvering operations from inside or outside a vehicle. The various personal communication devices may communicate with components of a vehicle, such as a vehicle controller, using various communication media and communication formats. For example, a smartphone may communicate with a vehicle controller via a cellular communication link and cellular communications infrastructure (cell towers, repeaters, etc.). As another example, a phablet or a laptop computer may communicate with a vehicle controller via a Bluetooth® communication link.

The phrase “gesture command” as used herein refers to any of various kinds of actions performed upon a personal communication device. Some example gesture commands may involve performing touch-related actions upon a touch screen of a personal communication device, moving the personal communication device in various directions, orienting the personal communication device at various angles, and moving the personal communication device in space at various speeds.

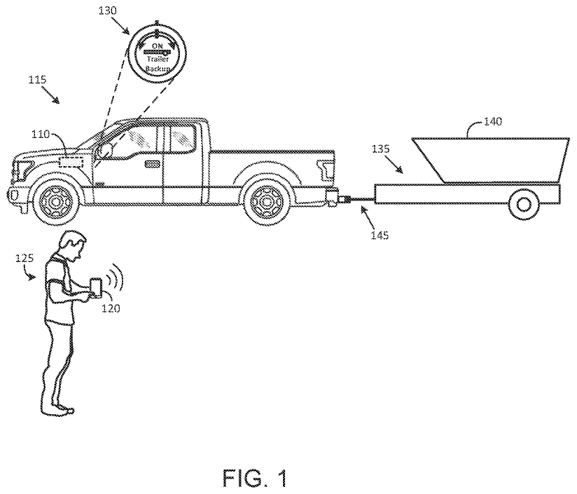

FIG. 1 illustrates a first example scenario of a remote-control vehicle maneuvering system operation in accordance with an embodiment of the disclosure. In this example scenario, an individual 125 uses a personal communication device 120 to maneuver a vehicle 115 for moving a trailer 135 backwards. The trailer 135 supports a boat 140. The individual 125 may, for example, be moving the trailer 135 in order to launch the boat 140 into a lake, or to park the trailer 135 in a parking spot, for example.

It must be understood that the vehicle 115, though illustrated as a truck, may take the form of any other passenger or commercial automobile such as, for example, a car, a sport utility, a crossover vehicle, a van, a minivan, a taxi, or a bus, in accordance with the disclosure. Similarly, in other scenarios, the trailer 135 may take the form of a camper, a goods container, a horse trailer, a flatbed, etc., in accordance with the disclosure.

The vehicle 115 may have various types of automotive drive systems in various applications. Example drive systems can include various types of internal combustion engine (ICE) powertrains having a gasoline, diesel, or natural gas-powered combustion engine with conventional drive components such as, a transmission, a drive shaft, a differential, etc.

In some cases, the vehicle 115 may be configured as an electric vehicle (EV). More particularly, the vehicle 115 may include a battery EV (BEV) drive system. The vehicle 115 may be configured as a hybrid EV (HEV) having an independent onboard power plant or a plug-in HEV (PHEV) that includes a HEV powertrain connectable to an external power source (including a parallel or series hybrid powertrain having a combustion engine power plant and one or more EV drive systems). HEVs can include battery and/or super capacitor banks for power storage, flywheel power storage systems, or other power generation and storage infrastructure.

The vehicle 115 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components. Further, in some cases, the vehicle 115 may be a manually driven vehicle, and/or be configured to operate in a fully autonomous or partially autonomous mode.

The trailer 135 is coupled to the vehicle 115 via a hitch 145 such that the vehicle 115 is able to pull or push the trailer 135 from one location to another location. The hitch 145 is configured to allow the trailer 135 to follow a path of the vehicle 115 when the vehicle 115 moves forward. The path of the trailer 135 when the vehicle 115 moves in reverse depends on the direction of force applied by the vehicle 115 at the hitch 145. If the longitudinal axes of the vehicle 115 and trailer 135 are aligned through the hitch 145, the reverse path is straight. If the longitudinal axis of the vehicle 115 and the longitudinal axis of the trailer 135 are at an angle, the reverse path has an angular shape.

The vehicle 115 can include various components such as a vehicle controller 110 that may be installed in an engine compartment of the vehicle 115 (as schematically illustrated in FIG. 1) or elsewhere in the vehicle 115. The vehicle controller 110 is arranged to cooperate with components of the vehicle 115 such as a fuel injection system and a speed control system, to control various operations of the vehicle 115. Some example functions may include controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In some cases, the vehicle controller 110 may include more than one computer, such as, for example, a first computer that controls engine operations and a second computer that performs actions such as managing an anti-theft system and/or an infotainment system provided in the vehicle 115.

In one example implementation in accordance with the disclosure, some or all parts of a remote-control vehicle maneuvering system may be incorporated into the vehicle controller 110. In another example implementation in accordance with the disclosure, a remote-control vehicle maneuvering system may be installed in the vehicle 115 in the form of a standalone device communicatively coupled to other devices such as the vehicle controller 110, the personal communication device 120, a server computer (via a wireless network), and one or more sensors mounted on the vehicle 115. In yet another example implementation in accordance with the disclosure, a remote-control vehicle maneuvering system may be provided in the personal communication device 120 that is configured to communicate with devices such as the vehicle controller 110, a server computer, and one or more sensors in the vehicle 115.

The movement of the vehicle 115 and trailer 135 may be controlled by an individual 125 in various ways. In a manual mode of operation, the individual 125 may manually control the movement of the vehicle 115 by operating a steering wheel and other components of the vehicle 115 such as an accelerator and a brake.

In another mode of operation, the individual 125 may control the movement of the vehicle 115 by operating a trailer backup knob 130 provided on a console panel of the vehicle 115. In this case, the individual 125 depresses an “ON” button on the trailer backup knob 130, moves a gear shifter of the vehicle 115 into reverse, and takes his/her hands off the steering wheel. The individual 125 then rotates the trailer backup knob 130 in a clockwise or a counter-clockwise direction so as to direct the vehicle controller 110 to move the vehicle backwards at a desired angle and desired direction.

In yet another mode of operation in accordance with the disclosure, the individual 125 uses the personal communication device 120 to issue remote-control commands that direct the vehicle controller 110 to move the vehicle backwards at a desired angle and desired direction. In one example application, the personal communication device 120 contains a software application that is launched by the individual 125 by use of a human machine interface (HMI) such as, for example, a touch screen of the personal communication device 120. The individual 125 then issues remote-control commands by using his/her fingers to initiate gesture commands upon the touch screen and/or by moving the personal communication device 120 in various ways. Some aspects pertaining to gesture commands are described below using other figures.

In some situations, the individual 125 may use the personal communication device 120 to issue remote-control commands while seated or standing inside the vehicle 115. In some other situations, the individual 125 may use the personal communication device 120 to issue remote-control commands while standing outside the vehicle 115, as illustrated in FIG. 1. The individual 125 may opt to stand outside the vehicle 115 for various reasons, such as, for example, to have an unrestricted view of the trailer 135 during a backup operation.

The location of the individual 125 (inside or outside the vehicle 115) may be determined in accordance with the disclosure by providing any of various devices in the vehicle 115 and/or the trailer 135. For example, one or more cameras can be provided in the vehicle 115 for capturing images that are transferred to the vehicle controller 110. A remote-control vehicle maneuvering system that may be a part of the vehicle controller 110 may analyze the images to determine a location of the individual 125.

As another example, the location of the individual may be determined in an indirect manner by identifying a location of the personal communication device 120 that is carried by the individual 125. In this scenario, the vehicle 115 may include one or more wireless communication nodes that are employed by a remote-control vehicle maneuvering system to determine a location of the personal communication device 120 with respect to the vehicle 115. The determination may be made by employing any of various wireless communication technologies, such as Bluetooth®, Ultra-Wideband (UWB), Wi-Fi, ZigBee®, or near-field-communications (NFC), and device locating procedures such as, for example, a received signal strength indication (RSSI) procedure, a time-of-flight (ToF) trilateration procedure, an Angle-of-Arrival (AoA) procedure, Angle-of-Departure (AoD) procedure, and/or a radio frequency identification (RFID) procedure.

In one example approach, determining the location of the individual 125 indirectly by locating the personal communication device 120 may be carried out by comparing a motion characteristic of the vehicle 115 to a motion characteristic of the personal communication device 120. The motion characteristic of the vehicle 115 may be obtained from one or more sensors attached to the vehicle 115 such as from an accelerometer or a piezo-electric sensor. The motion characteristic of the personal communication device 120 may be obtained from one or more sensors provided in the personal communication device 120 such as, for example, an accelerometer. Comparing the motion characteristic of the vehicle 115 to the motion characteristic of the personal communication device 120 may disclose similarities that indicate that the individual 125 is located inside the vehicle 115, or vice-versa (differences that indicate that the individual 125 is located outside the vehicle 115).

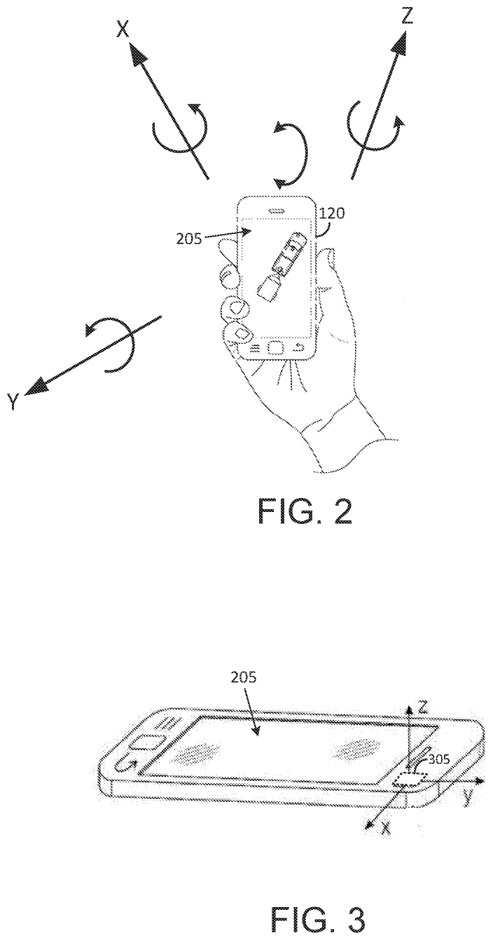

FIG. 2 illustrates some operational features of the personal communication device 120 used for maneuvering the vehicle 115 in accordance with the disclosure. The personal communication device 120 may include a processor and a computer-readable memory. The memory may be a non-transitory computer-readable memory that stores computer-executable instructions. The computer-executable instructions can be provided in the form of a software application that is executed by the processor to perform at least some operations associated with remote-control vehicle maneuvering in accordance with the disclosure.

When executing these operations, the personal communication device 120 may display various graphical images upon a display screen 205 of the personal communication device 120. The display screen 205 can be a touchscreen that operates as a human machine interface (HMI). In an example scenario, a graphic of the vehicle 115 and the trailer 135 may be displayed upon the display screen 205 and updated in real time during the remote-control vehicle maneuvering operation. The real time graphic can represent a controlled movement of the vehicle 115 and trailer 135 in a forward direction and/or in a reverse direction from a first location to a second location.

Additional graphics such as icons, buttons, and bars, may be provided on the display screen 205 to allow the individual 125 to enter gesture commands into the personal communication device 120 for maneuvering the vehicle 115. The gesture commands can be used to move the vehicle 115 and the trailer 135 in various directions, at various angles, and at various speeds.

In one example procedure, the individual 125 places both his/her thumbs upon the display screen 205, a touchscreen in this case, and rotates the personal communication device 120 about an axis that is perpendicular to the touchscreen in order to execute a gesture command that directs the vehicle controller 110 to move the vehicle 115 in such a manner as to obtain a desired curvilinear path and/or a desired angular orientation of the trailer 135.

In another example procedure, the individual 125 places both his/her thumbs upon the touchscreen of the personal communication device 120 and tilts the personal communication device 120 about an axis that is horizontal to the touchscreen in order to execute a gesture command that directs the vehicle controller 110 to change the speed of movement of the vehicle 115 when moving backwards. In some cases, the speed of movement of the vehicle 115 may be limited to a preset limit. The preset limit may be determined on the basis of factors such as safety and maneuverability.

In yet another example procedure, the individual 125 rotates the personal communication device 120 to a desired angle with respect to an axis for informing the vehicle controller 110 to take an action.

The personal communication device 120 can include various components for detecting gesture commands executed by the individual 125 upon the personal communication device 120, such as by moving the personal communication device 120 in any of various directions with respect to any of various axes. Rotational movements with respect to the x-axis, y-axis, and z-axis are illustrated in FIG. 2.

FIG. 3 illustrates some example components of the personal communication device 120 in accordance with an embodiment of the disclosure. More particularly, in this example illustration, the personal communication device 120 includes the display screen 205 and a sensor in the form of an accelerometer 305. The accelerometer 305 provides sensor signals for use by the remote-control vehicle maneuvering software application. The sensor signals may be processed by the remote-control vehicle maneuvering software application for various reasons such as, for example, interpreting gesture commands, determining a location of the personal communication device 120, and/or for providing warnings and notifications.

Interpreting gesture commands such as rotation and tilt, for example, can involve calculations that include applying gravitational acceleration (9.8 meters/sec²) to sensor signal amplitudes and representing the results of the calculations in the form of one or more acceleration vectors. An acceleration vector can indicate a magnitude of gravitational acceleration in a direction toward the surface of the earth. Certain gesture command characteristics can thus be represented in the form of vectors along the x-axis, the y-axis, and/or the z-axis of the personal communication device 120. Other gesture command characteristics may be represented in various other ways, such as, for example, by an angular deviation with respect to an axis. Thus, an angular deviation of 30 degrees with respect to the x-axis may indicate a first amplitude and an angular deviation of 45 degrees with respect to the x-axis may indicate a second amplitude that is greater than the first amplitude.

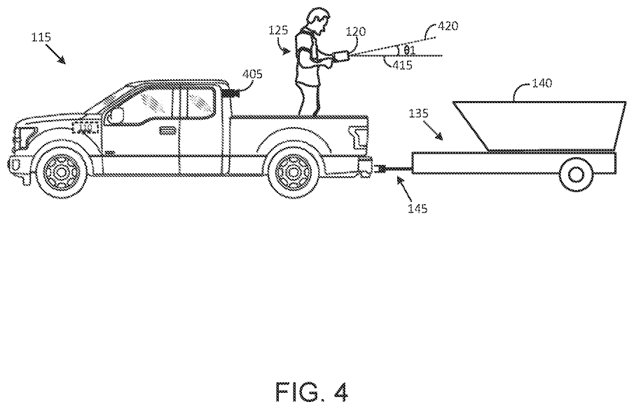

FIG. 4 illustrates a second example scenario of a remote-control vehicle maneuvering system operation in accordance with an embodiment of the disclosure. In this example scenario, the individual 125 is standing on a flatbed portion of the vehicle 115 while operating the personal communication device 120 to maneuver the trailer 135 backwards over a boat ramp and into a lake. The individual 125 may have opted to stand on the flatbed portion of the vehicle 115 various reasons such as, for example, to have an unobstructed view of the trailer 135 and/or to ensure that the trailer 135 does not slip off the boat ramp sideways before entering the lake.

The individual 125 may control the speed of the vehicle 115 by tilting the personal communication device 120 at an angle “θ1” with respect to a horizontal vector 415 that extends parallel to the ground on which the vehicle 115 is moving. The angular deviation (“θ1”) may be indicated by a vector 420 extending angularly above the horizontal vector 415 and represents a command by the individual 125 for moving the vehicle 115 at a first speed (2 mph, for example). An increase in the angular deviation can represent a command by the individual 125 to the vehicle 115 to move at a higher speed (5 mph, for example).

In this example scenario, a method to maneuver the vehicle 115 in accordance with the disclosure can include operating the remote-control vehicle maneuvering system to first determine a location of the individual 125. This procedure may be carried out by analyzing images received from a camera 405, for example. The camera 405 can send an image (a digital image, for example) and/or a video stream of images that show the individual 125 standing on the flatbed portion of the vehicle 115. After determining that the individual 125 is standing on the flatbed portion of the vehicle 115, the remote-control vehicle maneuvering system may execute various other operations in accordance with the disclosure. Some of these operations are described below using other figures.

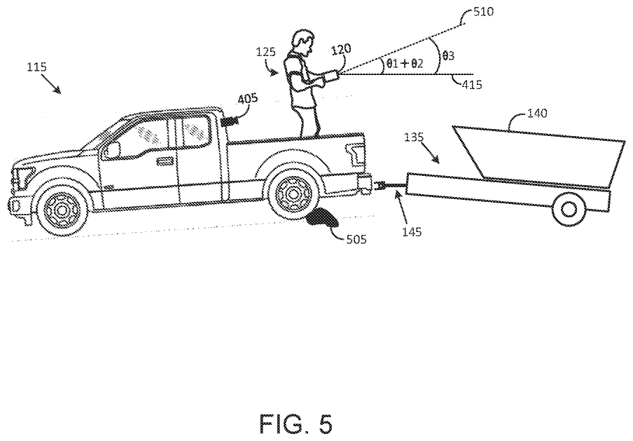

FIG. 5 illustrates an exemplary situation that may be encountered during the remote-control vehicle maneuvering vehicle operation illustrated in FIG. 4. While moving backwards, the vehicle 115 may encounter an object 505 located on the travel surface. The object 505 causes a rear portion of the vehicle 115 to lift, thereby causing the individual 125 to lean backwards as shown. Upon leaning backwards, the personal communication device 120 is tilted upwards thereby changing the angle “θ1” shown in FIG. 4 to a greater angle “θ3” with respect to the horizontal vector 415. The greater angle “θ3” that is defined by a vector 510, contains the angle “θ1” and an additional angle “θ2.” The change in angle can cause the speed of the vehicle 115 to change abruptly if left uncorrected. Such changes to a desired remote-control maneuvering operation (in this example, an angular increase) can be referred to as vehicle motion interference and it is desirable to eliminate such vehicle motion interference in accordance with the disclosure. In the example situation illustrated in FIG. 5, the elimination of the vehicle motion interference can be carried out by eliminating angle “θ2,” which may, for example, be carried out by subtracting the angular deviation “θ2” from the angular deviation “θ3” so as to obtain the desired angle “θ1.”

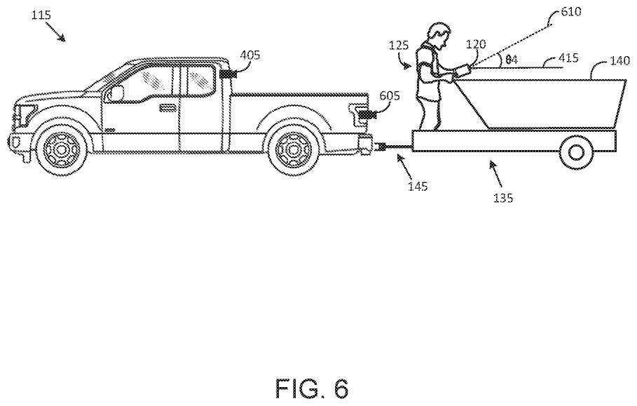

FIG. 6 illustrates a third example scenario of a remote-control vehicle maneuvering system operation in accordance with an embodiment of the disclosure. In this example scenario, the individual 125 is standing on the trailer 135 while operating the personal communication device 120 to maneuver the vehicle 115 for pushing the trailer 135 backwards over a boat ramp (not shown) and into a lake (not shown). The individual 125 may have opted to stand on the trailer for various reasons such as, for example, to ensure that the trailer 135 does not slip off the boat ramp sideways before entering the lake and/or because the vehicle 115 may lack a suitable place (such as a flatbed) for standing.

The individual 125 controls the speed of the vehicle 115 by tilting the personal communication device 120 at an angle “θ4” with respect to a horizontal vector 415 that extends parallel to the ground on which the vehicle 115 is moving. The angular deviation (“θ4”) may be indicated by a vector 610 extending angularly above the horizontal vector 415, and represents a command by the individual 125 to the vehicle 115 to move at a first speed (5 mph, for example). A decrease in the angular deviation can represent a command by the individual 125 to the vehicle 115 to move at a slower speed (2 mph, for example).

In this example, the remote-control vehicle maneuvering system may determine a location of the individual 125 by analyzing images received from a camera 405 and/or a camera 605 coupled to the remote-control vehicle maneuvering system. The camera 605, for example, can send an image (a digital image, for example) and/or a video stream of images that show the individual 125 standing on the trailer 135. The remote-control vehicle maneuvering system may use this information for performing various operations in accordance with the disclosure.

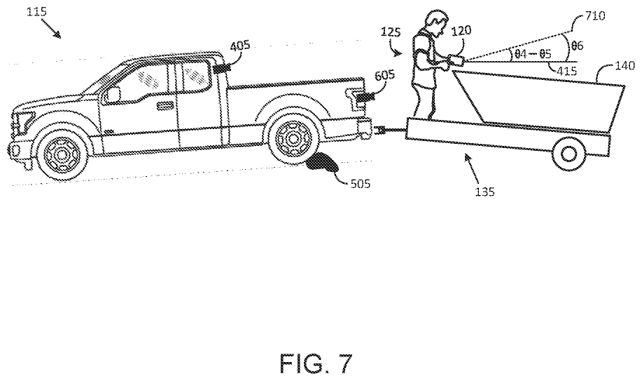

FIG. 7 illustrates an exemplary situation that may be encountered during the remote-control vehicle maneuvering vehicle operation illustrated in FIG. 6. As in the example described above, the vehicle 115 encounters an object 505 on the travel surface while moving in reverse. The object 505 not only causes the rear portion of the vehicle 115 to lift but also lifts a portion of the trailer 135 on which the individual 125 is standing. Lifting of the trailer 135 causes the individual 125 to lean forwards.

Upon leaning forwards, the personal communication device 120 is tilted downwards thereby changing the angle “θ4” shown in FIG. 6 to a smaller angle “θ6” with respect to the horizontal vector 415. The smaller angle “θ6” defined by the vector 710 has an angle “θ5” subtracted from the angle “θ4.” The change in angle can cause the speed of the vehicle 115 to change abruptly if left uncorrected. In this example situation illustrated in FIG. 7, the elimination of the vehicle motion interference can be carried out by eliminating angle “θ5,” which may, for example, be carried out by adding the angular deviation “θ5” to the angular deviation “θ6” so as to obtain the desired angle “θ4.”

The example situations described above pertain to eliminating vehicle motion interference by using adding and subtracting methods. In other example situations, vehicle motion interference may be eliminated by using various other methods, including the use of various mathematical operators, equations, and algorithms. Mathematical operators, equations, and algorithms can include, for example, linear operators, nonlinear operators, linear equations, nonlinear equations, curve fitting techniques, recursive operations, error-minimization operations, number-crunching operations, templates, historical data, learned data, and personal preferences of the individual 125.

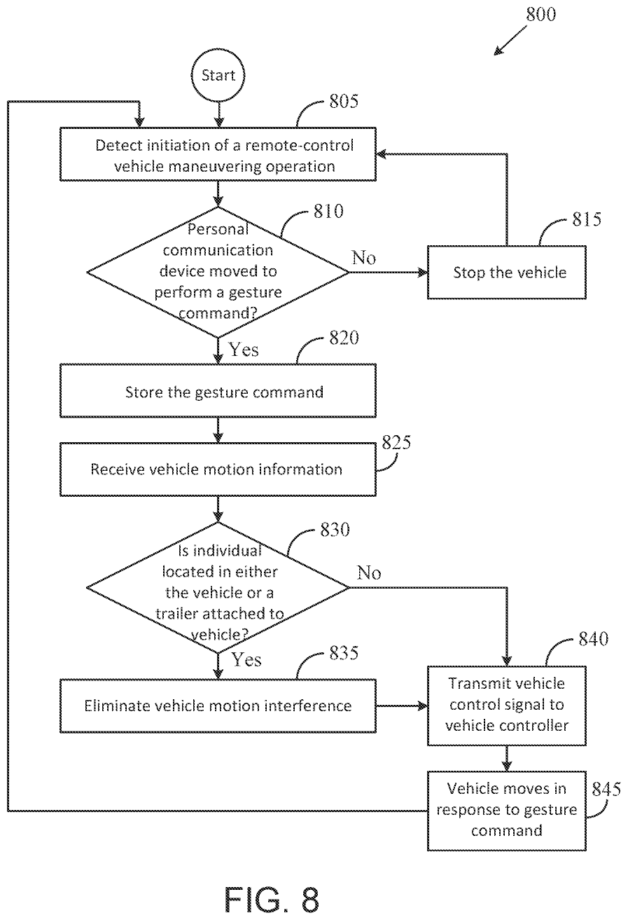

FIG. 8 shows a flowchart 800 of an example method in accordance with the disclosure to eliminate vehicle motion interference during a remote-control vehicle maneuvering operation. The flowchart 800 illustrates a sequence of operations that can be implemented in hardware, software, or a combination thereof. In the context of software, the operations represent computer-executable instructions stored on one or more non-transitory computer-readable media, such as a memory contained in the personal communication device 120 or in the vehicle controller 110, that, when executed by one or more processors, such as a processor in the personal communication device 120 or in the vehicle controller 110 respectively, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 800 may be carried out by a personal communication device and/or a vehicle controller. The description below may make reference to certain components and objects shown in other figures (the personal communication device 120 and the vehicle controller 110, for example) but it should be understood that this is done for purposes of explaining certain aspects of the disclosure and that the description is equally applicable to various other components in various embodiments.

At block 805, an action carried out by the individual 125 to initiate a remote-control vehicle maneuvering operation may be detected. An example action may include the individual 125 launching a remote-control vehicle maneuvering software application on the personal communication device 120. Another example action may involve the individual 125 placing both thumbs upon a touchscreen of the personal communication device 120 after placing the vehicle 115 in reverse gear. The vehicle controller 110 may start moving the vehicle 115 backwards when the vehicle 115 is placed in reverse gear and in anticipation of remote-control commands from the individual 125.

At block 810, a determination is made whether the individual 125 has performed a motion of the personal communication device 120 for executing a remote-control vehicle maneuvering operation. For example, the individual 125 may move the personal communication device 120 in accordance with a gesture command, such as, for example, tilting the personal communication device 120 downwards to increase the speed of movement of the vehicle 115, tilting the personal communication device 120 upwards to decrease the speed of movement of the vehicle 115, and/or rotating the personal communication device 120 around a horizontal axis of the personal communication device 120.

If the individual 125 has not made any gesture command, at block 815, the vehicle controller 110 may stop the vehicle 115 and wait for the individual 125 to once again initiate a remote-control vehicle maneuvering operation (at block 805).

If the individual 125 has carried out a gesture command upon the personal communication device 120, at block 820, the personal communication device 120 may, in one example implementation, store information regarding the gesture command in a memory of the personal communication device 120 for carrying out some additional operations before generating a vehicle control signal in accordance with the disclosure. In another example implementation, the personal communication device 120 may generate a vehicle control signal based on the gesture command and store the vehicle control signal in memory and carry out additional operations described below.

At block 825, the personal communication device 120 may receive a sensor signal that provides motion information about the vehicle 115 and/or the trailer 135. The sensor signal, which may be provided by one or more sensors attached to the vehicle 115 and/or the trailer 135, may contain information indicating various conditions such as, for example, a tilting of a chassis of the vehicle 115, a tilting of a part in the vehicle 115, a vibration in the vehicle 115, and/or a change in speed of the vehicle 115. Such conditions may occur under various scenarios such as those described above with reference to FIG. 5 and/or FIG. 7. In some cases, the tilting of the vehicle 115 and/or the trailer 135 may simulate a gesture command applied to the personal communication device 120 by the individual 125.

At block 830, a determination is made whether the individual 125 is present in the vehicle 115, in the trailer 135, or outside the vehicle 115. If the individual 125 is present in the vehicle 115 or in the trailer 135, a further determination may be made as to the effect of the motion activity of the vehicle 115 or the trailer 135, respectively, upon the gesture command performed by the individual 125 upon the personal communication device 120.

At block 835, the vehicle motion interference caused by the motion activity is eliminated. This action may be carried out in various ways, such as, for example, by adding the sensor signal to the vehicle control signal that is generated at block 820, subtracting the sensor signal from the vehicle control signal that is generated at block 820, compensating for the sensor signal, and/or counteracting the sensor signal in various ways. In some applications, eliminating the vehicle motion interference may be carried out by subtracting a first angular deviation from a second angular deviation, or by adding the first angular deviation to the second angular deviation as described above. The first angular deviation is based on the sensor signal and the second angular deviation is based on the personal communication device.

At block 840, in one example implementation, the personal communication device 120 transmits the vehicle control signal to the vehicle controller 110 after eliminating the vehicle motion interference. In another example implementation, the personal communication device 120 transmits the vehicle control signal and the sensor signal to the vehicle controller 110 without eliminating the vehicle motion interference from the vehicle control signal. The vehicle controller 110 eliminates the vehicle motion interference before controlling the movement of the vehicle 115.

At block 845, the vehicle 115 responds to the vehicle control signal provided by the vehicle controller 110 and moves in accordance with the intended gesture command initiated by the individual 125 upon the personal communication device 120.

Referring back to block 830, if the determination is made that the individual 125 is outside the vehicle 115 there is no need to eliminate vehicle motion interference. As a result, at block 840, the personal communication device 120 communicates with the vehicle controller 110 to move the vehicle 115 in accordance with the intended gesture command initiated by the individual 125 upon the personal communication device 120.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as a memory provided in the personal communication device 120 can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
determining a motion of a personal communication device for maneuvering a vehicle, wherein the personal communication device is located on the vehicle;
determining a motion of the vehicle; and
maneuvering, based on eliminating a motion interference caused by the motion of the vehicle upon the motion of the personal communication device, the vehicle.

2. The method of claim 1, wherein the motion of the personal communication device is a first gesture command for maneuvering a trailer attached to the vehicle, the first gesture command applied to the personal communication device by an individual who is located in the vehicle.

3. The method of claim 2, wherein the motion of the vehicle simulates one of the first gesture command or a second gesture command applied to the personal communication device.

4. The method of claim 2, wherein the motion of the vehicle comprises a tilting of a chassis of the vehicle, a tilting of a part in the vehicle, a vibration in the vehicle, and/or a change in speed of the vehicle.

5. The method of claim 2, wherein determining the motion of the vehicle comprises receiving a sensor signal from a sensor mounted on the vehicle, and wherein eliminating the motion interference comprises one of subtracting a first angular deviation from a second angular deviation or adding the first angular deviation to the second angular deviation, the first angular deviation based on the sensor signal and the second angular deviation based on the personal communication device.

6. The method of claim 5, further comprising:
providing a remote-control command signal to a vehicle controller of the vehicle for maneuvering the trailer based on the first gesture command.

7. A method comprising:
determining a motion of a personal communication device for maneuvering a vehicle and/or a trailer attached to the vehicle;
eliminating a motion interference caused by a motion of the vehicle and/or the trailer upon the motion of the personal communication device; and
maneuvering, in response to the motion of the personal communication device and based on eliminating the motion interference, the vehicle and/or the trailer.

8. The method of claim 7, wherein the motion of the personal communication device is a first gesture command applied upon the personal communication device by an individual who is located in one of the vehicle or the trailer attached to the vehicle.

9. The method of claim 8, wherein eliminating the motion interference comprises one of subtracting a first angular deviation from a second angular deviation or adding the first angular deviation to the second angular deviation, the first angular deviation based on the motion interference and the second angular deviation based on the motion of the personal communication device.

10. The method of claim 8, wherein the motion of the vehicle simulates one of the first gesture command or a second gesture command applied to the personal communication device.

11. The method of claim 10, wherein the first gesture command is directed at moving the vehicle and/or the trailer in a first direction and the second gesture command is directed at moving the vehicle and/or the trailer in a second direction.

12. The method of claim 8, wherein the first gesture command is based on the individual placing a left thumb and a right thumb on a display screen of the personal communication device and one of moving or tilting the personal communication device.

13. The method of claim 12, further comprising:
detecting a location of the personal communication device in one of the vehicle or the trailer attached to the vehicle; and
determining that the individual is located in one of the vehicle or the trailer attached to the vehicle based on detecting the location of the personal communication device in a corresponding one of the vehicle or the trailer attached to the vehicle.

14. A vehicle maneuvering system comprising:
a sensor configured to sense a motion of a vehicle and/or a trailer attached to the vehicle;
a personal communication device communicatively coupled to the sensor, the personal communication device comprising:
a memory that stores computer-executable instructions; and
a processor configured to access the memory and execute the computer-executable instructions to at least:
identify a motion of the personal communication device for maneuvering the vehicle and/or the trailer attached to the vehicle;
determine a motion of the vehicle and/or the trailer based on a sensor signal received from the sensor; and
maneuver the vehicle, based on eliminating a motion interference caused by the motion of the vehicle and/or the trailer upon the motion of the personal communication device.

15. The vehicle maneuvering system of claim 14, wherein eliminating the motion interference comprises one of subtracting a first angular deviation from a second angular deviation or adding the first angular deviation to the second angular deviation, the first angular deviation based on the sensor signal and the second angular deviation based on the motion of the personal communication device.

16. The vehicle maneuvering system of claim 14, wherein the motion of the vehicle and/or the trailer comprises a tilting of a chassis of the vehicle and/or the trailer, a tilting of a part in the vehicle and/or the trailer, a vibration in the vehicle and/or the trailer, and/or a change in speed of the vehicle.

17. The vehicle maneuvering system of claim 16, wherein the motion of the personal communication device comprises a first gesture command, and wherein the personal communication device is configured to receive the first gesture command, interpret the first gesture command, and cooperate with a vehicle controller in the vehicle to execute the first gesture command.

18. The vehicle maneuvering system of claim 17, wherein the motion of the vehicle and/or the trailer simulates one of the first gesture command or a second gesture command applied to the personal communication device.

19. The vehicle maneuvering system of claim 18, wherein the first gesture command is directed at moving the vehicle and/or the trailer in a first direction and the second gesture command is directed at moving the vehicle and/or the trailer in a second direction.

20. The vehicle maneuvering system of claim 14, wherein the sensor is one of a speed sensor, an accelerometer, a wheel sensor, a trailer angle sensor, or an imaging device.
